(19) United States
(12) Patent Application Publication
(10) Pub. No.: US 2017/0097795 A1
(43) Pub. Date: Apr. 6, 2017

(54) STORAGE SYSTEM

(71) Applicant: Hitachi, Ltd., Tokyo (JP)

(72) Inventors: Tadato NISHINA, Tokyo (JP); Tomohiro YOSHIHARA, Tokyo (JP); Hiroaki AKUTSU, Tokyo (JP); Junji OGAWA, Tokyo (JP); Shunji KAWAMURA, Tokyo (JP)

(21) Appl. No.: 15/127,838

(22) PCT Filed: Apr. 7, 2014
(86) PCT No.: PCT/JP2014/060126

§ 371 Date: Sep. 21, 2016

(51) Int. Cl. G06F 3/06; G06F 12/0802

(52) U.S. Cl. CPC G06F 3/0659; G06F 3/0604; G06F 3/0653; G06F 3/0688; G06F 12/0802; G06F 2212/60

(57) ABSTRACT

In a flash storage system, the amount of write to be performed to a flash memory of a flash storage can be reduced without deteriorating the performance of a storage controller and the flash storage. When the storage controller performs collective write of data including intermittent reads to the flash storage, the storage system issues a compare write request to the flash storage. The flash storage having received the compare write request reads a data before update of the written data range from the flash memory, compares the read data with the written data, and writes only the data having a different content to the flash memory.

### TECHNICAL FIELD

The present invention relates to a storage system using a flash memory as a storage device, and a method for controlling the same.

### BACKGROUND ART

In a storage controller of a storage system, multiple write data arriving from a superior device such as a host computer is temporarily stored in a disk cache. Thereafter, when storing the write data stored in a disk cache to a final storage device, such as an HDD, the write data of a fixed address range may be written collectively to the storage device (collective write). At that time, areas where the write data have arrived and areas where write data have not arrived may exist in a mixture within the relevant fixed address range. Regarding the area where write data has arrived, the write data exists in the disk cache, but regarding the area where write data has not arrived, data does not exist in the disk cache. In that case, data that does not exist in the disk cache is read from the storage device to the cache (intermittent read), according to which the write to the storage device can be completed by only a single write, and the efficiency is enhanced.

During the above-illustrated collective write, the data read from the storage device (data not updated by the host) will also be written. In the case of a flash storage where a flash memory is used as the storage media by the storage device, the number of writes to a flash memory is increased, and the rewrite life of the flash memory is thereby shortened.

An art as disclosed in Patent Literature 1 is known to elongate the life of flash memories. Patent Literature 1 discloses an art where a storage device using a storage media such as a flash memory having an upper limit to the possible number of rewrites reads a data before update (old data) from the storage media prior to storing an update request data (new data) from a superior device to a storage media, compares the new data with the old data, and if the data do not correspond, the whole new data is written to the storage device, but if they do correspond, the new data will not be written to the storage device. According to this technique, the new data having a same content as the old data will not be written to the storage device, so that the number of rewrites of the storage media will be reduced, and as a result, the life of the storage media can be elongated.

### CITATION LIST

### Patent Literature

### [PTL 1] US Patent Application Publication No. 2008/0082744

### [PTL 2] US Patent Application Publication No. 2013/0290773

### SUMMARY OF INVENTION

### Technical Problem

When the technique disclosed in Patent Literature 1 is applied to a storage RAID controller, an additional process becomes necessary for the RAID storage controller to read and compare the data before update corresponding to the update target data (hereinafter, this process is called “read compare”), so that the process load of the RAID storage controller is increased, and the performance of the storage system is deteriorated.

When this technique is simply applied to a storage device, the read compare must always be performed when writing update data. For example, in a sequential write where a long data must be written, an intermittent read as mentioned earlier will rarely occur, so that when write is performed without using the technique disclosed in Patent Literature 1, the possibility of data not being updated by the host to be written is extremely small. When the art taught in Patent Literature 1 is simply applied, read compare is executed even in the above case, so that the performance of the storage system is still deteriorated.

The object of the present invention is to cut down the amount of writes to the storage device without deteriorating the performance of the RAID storage controller and the storage devices.

### Solution to Problem

The storage system according to the present invention at least comprises a controller and one or more storage devices having a nonvolatile storage device. When the storage system stores the write data from the host computer to the storage device, it transmits a command including an instruction related to a storage range of write data, and the write data. The storage device having received the command compares the data before update of the write data stored in the storage range of the storage device with the write data, and stores only the portion having a different content to the storage device.

### Advantageous Effects of Invention

According to the present invention, the number of rewrites to the flash memory can be reduced without deteriorating the performance of the storage system.

### BRIEF DESCRIPTION OF DRAWINGS

FIG. 1 is a hardware configuration diagram of a computer system according to Embodiment 1.

FIG. 2 is a hardware configuration diagram of a flash storage according to Embodiment 1.

FIG. 3A shows programs and tables stored in an LM of a storage subsystem according to Embodiment 1.

FIG. 3B shows programs stored in a package memory of a flash storage according to Embodiment 1.

FIG. 4 is a configuration example of a compare write support management table according to Embodiment 1.

FIG. 5 illustrates one example of a collective write according to Embodiment 1.

FIG. 6 is a flowchart of a collective write process of a storage controller according to Embodiment 1.

FIG. 7 is a flowchart of a compare write process of a flash storage according to Embodiment 1.

FIG. 8A shows programs and tables stored in an LM of a storage subsystem according to Embodiment 2.

FIG. 8B shows programs stored in a package memory of a flash storage according to Embodiment 2.

FIG. 9 shows one example of a collective write according to Embodiment 2.

FIG. 10 is a flowchart of a collective write process in a storage controller according to Embodiment 2.

FIG. 11 is a flowchart of a compare write process of the flash storage according to Embodiment 2.

FIG. 12A illustrates programs and tables stored in an LM of a storage subsystem according to Embodiment 3.

FIG. 12B illustrates programs stored in a package memory of a flash storage according to Embodiment 3.

FIG. 13A shows the contents of a write method determination information table.

FIG. 13B shows a configuration example of drive information entries within the write method determination information table.

FIG. 14 is a flowchart of a collective write process of a storage controller according to Embodiment 3.

FIG. 15 is an example of a basis of determination of the write method of a storage controller according to Embodiment 3.

FIG. 16 illustrates one example of a collective write according to Embodiment 4.

FIG. 17A illustrates programs and tables stored in an LM of a storage subsystem according to Embodiment 4.

FIG. 17B illustrates programs stored in a package memory of a flash storage according to Embodiment 4.

FIG. 18 illustrates a flowchart of a collective write process of a storage controller according to Embodiment 4.

FIG. 19 is a flowchart of an update position designation write process of a flash storage according to Embodiment 4.

FIG. 20 shows one example of a data format when the storage controller according to Embodiment 4 transfers data to the storage device.

### DESCRIPTION OF EMBODIMENTS

Now, the preferred embodiments of the present invention will be described with reference to the drawings. In the drawing, the same portions are denoted with the same reference numbers. However, the present invention is not restricted to the present embodiments, and any application example in compliance with the idea of the present invention is included in the technical scope of the present invention. The number of components can be one or more than one, unless defined otherwise.

In the following description, various information are referred to as “xxx tables”, for example, but the various information can also be expressed by data structures other than tables. Further, the “xxx table” can also be referred to as “xxx information” to indicate that the information does not depend on the data structure.

The processes are sometimes described using the term “program” as the subject, however, the program is executed by a processor such as a CPU (Central Processing Unit) for performing determined processes, so that a processor can also be the subject of the processes since the processes are performed using appropriate storage resources (such as memories) and communication interface devices (such as communication ports). The processor can also use dedicated hardware in addition to the CPU. The computer programs can be installed to each computer from a program source, such as a program distribution server or a storage media.

Each element (such as each drive) are managed in an identifiable manner using IDs, numbers and the like, but any type of identification information, such as names, can be used as long as they are identifiable information.

### Embodiment 1

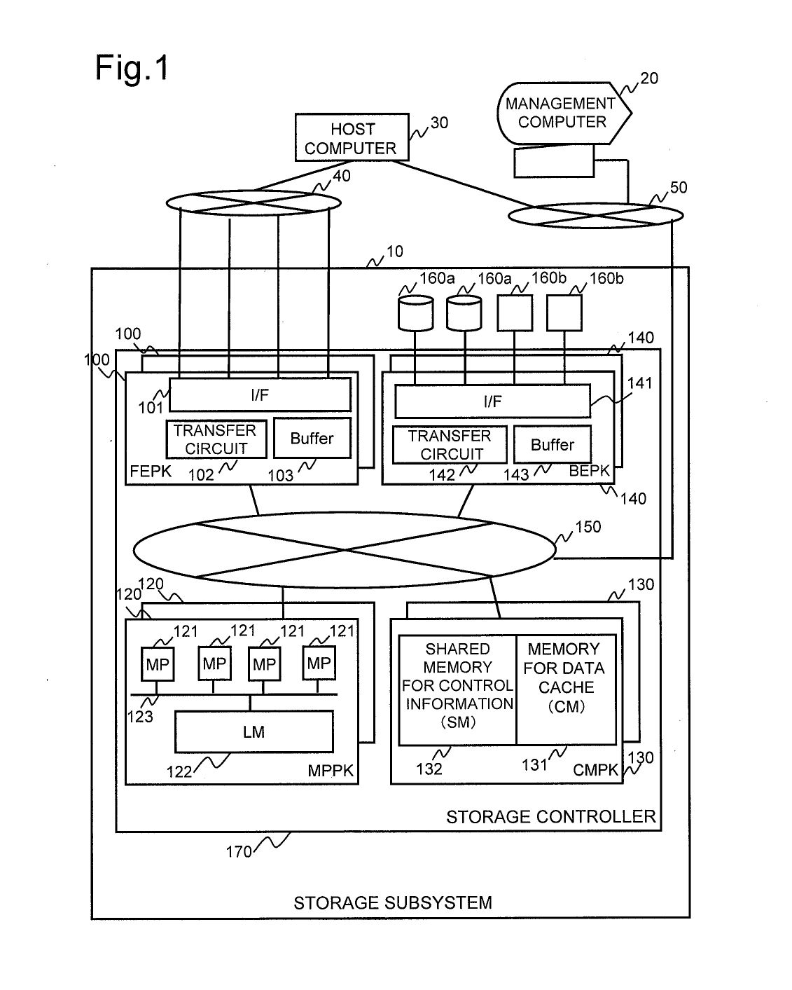

Embodiment 1 of the present invention will be described with reference to FIGS. 1 through 6. FIG. 1 is a hardware configuration diagram of a computer system according to Embodiment 1.

A computer system is composed of one or more host computers (hereinafter also referred to as host) 30, a management computer 20 and a storage subsystem 10.

The host computer 30 and the storage subsystem (also referred to as storage system) 10 are connected via a data network 40. The data network 40 is a SAN (Storage Area Network) composed of a combination of Fibre Channel cables and Fibre Channel switches, for example. The data network 40 can be an IP network or any other type of data communication network.

The host computer 30, the management computer 20 and the storage subsystem 10 are connected via a management network 50. The management network 50 can be, for example, an IP network. The management network 50 can be a local area network, a wide area network, or any other type of network. The data network 40 and the management network 50 can be a same network.

The storage subsystem 10 includes multiple storage devices (also called drives) 160 (160a, 160b) and a storage controller 170 for storing data (user data) transmitted from the host computer. The storage devices 160 included in the storage subsystem 10 adopt a Hard Disk Drive (HDD) having a magnetic disk, which is a nonvolatile storage media, a Solid State Drive (SSD) having a nonvolatile semiconductor memory, and a flash storage or the like having a compare write process function described later. The storage subsystem 10 is not restricted to a configuration where only a specific single type of storage device is installed. It is possible to have HDDs, SSDs, flash storages and the like installed in a mixture.

The storage subsystem 10 according to the preferred embodiment of the present invention manages the multiple storage devices 160 as one or multiple RAID (Redundant Arrays of Inexpensive/Independent Disks) groups. When storing write data from the host computer 30 to the RAID group composed of (n+m) number of storage devices 160 (n≧1, m≧1), write data can be stored in a distributed manner to n number of storage devices 160, and m number of redundant data (parity) are generated based on the write data, wherein the parity data is stored in given areas of the remaining m number of storage devices. Thereby, it becomes possible to prevent data loss when failure occurs to a single storage device 160.

The storage controller 170 is composed of a frontend package (FEPK) 100 for connecting to the host computer, a backend package (BEPK) 140 for connecting to the storage devices 160, the cache memory package (CMPK) 130 having a cache memory, a microprocessor package (MPPK) 120 having a microprocessor performing internal processes, and an internal network 150 connecting the same. As shown in FIG. 1, the storage subsystem 10 according to the present embodiment has multiple FEPKs 100, multiple BEPKs 140, multiple CMPKs 130, and multiple MPPKs 120.

Each FEPK 100 has an interface (I/F) 101 for connecting to the host computer 30, a transfer circuit 102 for performing data transfer within the storage subsystem 10, and a buffer 103 for temporarily storing data mounted on a board. The interface 101 can include multiple ports, and each port can be connected to devices that are connected to the SAN 40 of the host computer 30 or the like. The interface 101 converts the protocol used for the communication between the host computer 30 and the storage subsystem 10, such as Fibre Channel (FC), iSCSI (internet SCSI) or Fibre Channel Over Ethernet (FCoE), to a protocol used in the internal network 150, such as PCI-Express.

Each BEPK 140 has an interface (I/F) 141 for connecting with the storage devices 160, a transfer circuit 142 for performing data transfer within the storage subsystem 10, and a buffer 143 for temporarily storing data on a board. The interface 141 can include multiple ports, and each port is connected to the storage device 160. The interface 141 converts the protocol used for communicating with the storage devices 160, such as a FC, to a protocol used in the internal network 150.

Each CMPK 130 has a cache memory (CM) 131 for temporarily storing user data read or written by the host computer 30, and a shared memory (SM) 132 for storing the control information handled by one or multiple MPPKs 120 on a board. Multiple MPPKs 120 (microprocessors thereof) which are in charge of different volumes can access the shared memory 132. Data and programs handled by MPPKs 120 are loaded from the nonvolatile memory or the storage devices 160 within the storage subsystem 10. The cache memory 131 and the shared memory 132 can be loaded on different boards (packages).

Each MPPK 120 has one or more microprocessors (also referred to as processors) 121, a local memory (LM) 122, and a bus 123 connecting the same. Multiple microprocessors 121 are loaded according to the present embodiment. However, the number of the microprocessor 121 can be one. At least, in the scope of the embodiment of the present invention described hereafter, it is possible to recognize that the multiple microprocessors 121 are substantially a single processor. The local memory 122 stores programs executed by the microprocessors 121 and control information used by the microprocessors 121.

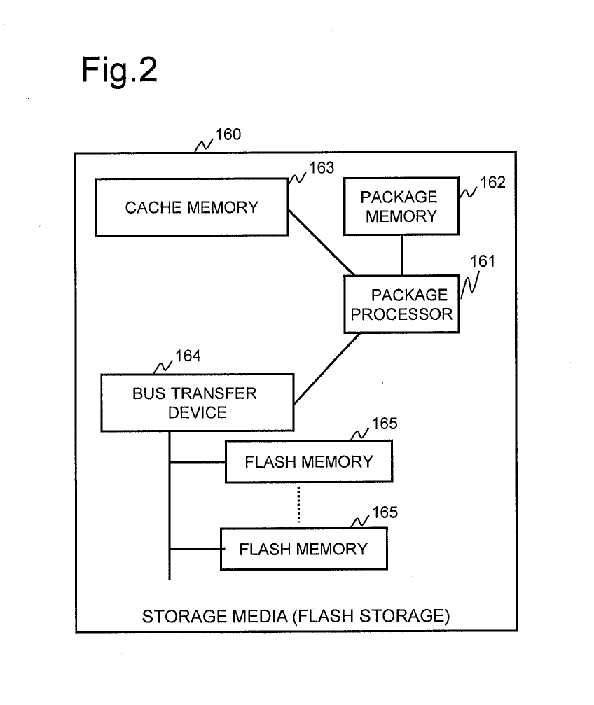

FIG. 2 is a view illustrating a configuration example of a flash storage, which is an example of the storage device 160 according to Embodiment 1.

A flash storage 160b includes a package processor 161 and a package memory 162, a cache memory 163, a bus transfer device 164, and one or more flash memories 165 which are storage media for storing write data from the storage controller 170. Further, it includes a port (not shown) for connecting with an external device, such as (the interface 141 of the BEPK 140 within) the storage controller 170.

The package memory 162 stores the programs executed by the package processor 161 and control information used by the package processor 161. The cache memory 163 temporarily stores the user data read or written by the storage controller 170.

The flash storage 160b according to Embodiment 1 of the present invention supports the compare write process function described hereafter. A compare write process function, the details of which will be described later, is a function that compares a write data (new data) with a data before update (old data) of the new data at the time of data write, and store only the portion where contents differ between the new data and the old data in the storage device. In the following description, if it is necessary to distinguish the flash storage 160b supporting the compare write process function from a conventional storage device such as the SSD or the HDD that does not support the compare write process function, the storage 160b is referred to as “the flash storage 160b” or the “storage device (flash storage) 160b”. Further, if the flash storage 160b supporting the compare write process function is not needed to be distinguished from other storage devices (storage devices that do not support the compare write process function), it is referred to as “the storage device 160”.

The configuration of the flash storage 160b is not restricted to the configuration illustrated with reference to FIG. 2, and it is also possible to implement the respective functions described in the preferred embodiments of the present invention to an SSD, for example.

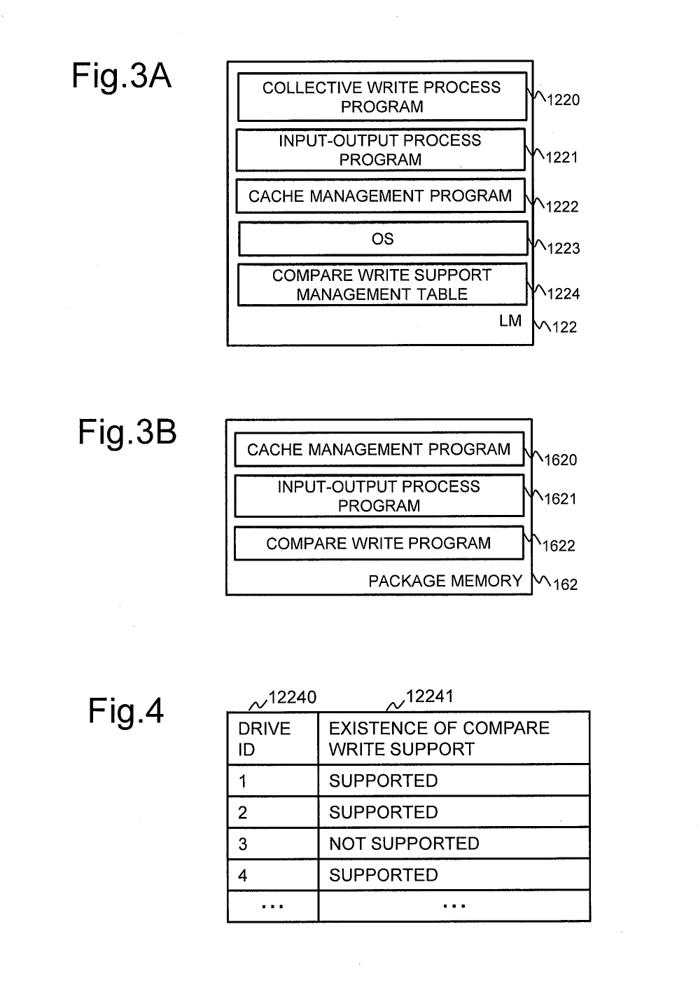

FIG. 3A illustrates an example of programs and control information stored in an LM 122 of the storage controller 170 according to Embodiment 1. The LM 122 stores a collective write process program 1220, an input-output process program 1221, a cache management program 1222, an OS 1223, and a compare write support management table 1224. The compare write support management table 1224 can be stored in the SM 132, or the CM 131, or the storage devices 160.

FIG. 3B illustrates an example of programs stored in the package memory 162 within the flash storage 160b according to Embodiment 1. The package memory 162 stores a cache management program 1620, an input-output process program 1621, and a compare write program 1622.

FIG. 4 is a view illustrating a configuration example of a compare write support management table according to Embodiment 1. The compare write support management table 1224 has a drive ID column 12240 and a compare write support existence column 12241.

Identifiers for independently identifying the storage devices 160 connected to the storage controller 170 are stored in the drive ID column 12240. Information indicating whether the storage device 160 specified by the identifier stored in the drive ID column 12240 is a storage device supporting a compare write process function described later or not is stored in the compare write support existence column 12241. For example, “supported” is stored if the storage device 160 supports the compare write process function, and “not supported” is stored if the storage device 160 does not support the compare write process function.

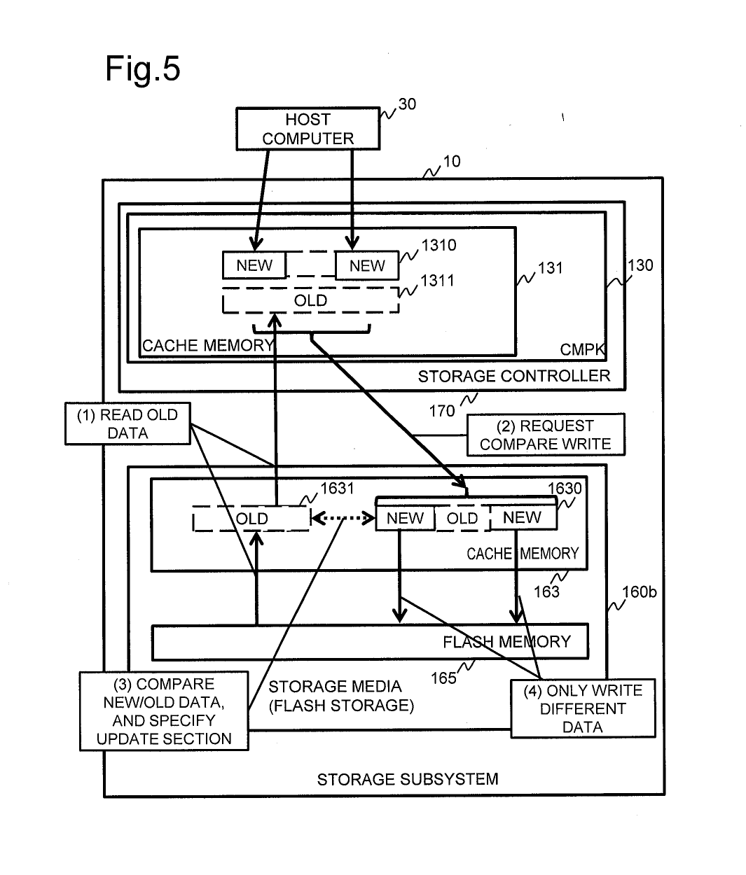

Next, the outline of the data storage process to the flash storage 160b executed in the storage subsystem 10 according to Embodiment 1 of the present invention will be described with reference to FIG. 5.

It includes a storage subsystem 10, and a host computer 30 issuing I/O requests. The storage subsystem 10 includes the CMPK 130 and the flash storage 160b. A new data 1310 written from the host and old data 1311 read from the flash storage 160b are stored in the cache memory 131 within the CMPK 130.

The flash storage 160b includes the cache memory 163 and the flash memories 165, and new data 1630 written from the storage controller 170 and old data 1631 read from the flash memory are temporarily stored in the cache memory 163.

The host computer 30 transmits a write request (write command) and the write data accompanying the write request to the storage subsystem. The storage controller 170 within the storage subsystem collectively writes the write data to be stored in a fixed address range of the flash storage 160b (a fixed address range refers for example to the range corresponding to the size of a stripe (or an integral multiple of the stripe) which is the unit of distributed storage of data to the RAID group) out of the multiple write data from the host computer 30 to the flash storage 160b (collective write). Therefore, multiple areas of update portions exist within the fixed address range. In FIG. 4, the boxes noted “new” existing in the cache memory 131 represent the update portions. In FIG. 4, there are two update sections, but it is possible to have three or more update sections included therein.

The storage controller 170 reads the old data 1311 from the flash storage 160b to complement the data of the area not updated by the host computer 30 within the fixed address range. The storage controller 170 merges the new data 1310 written from the host 30 and the old data 1311 read from the flash storage 160b, and issues a compare write request (a command instructing to execute the compare write process function) to the flash storage 160b. A compare write request includes information of the write destination address range in the flash storage 160b of the write target data (new data 1310 merged with the old data 1311), similar to a normal write request. Further, the information on the address range is normally composed of an initial address and a data length, but it can also be composed of other information (such as the initial address and end address).

The new data 1630 written to the flash storage 160b has an area of the new data 1310 updated by the host write and an area of the old data 1311 read from the flash storage 160b. The flash storage 160b having received the compare write request compares the old data 1630 stored in the flash storage 160b with the new data 1630 received by the compare write request, and specifies the update portion.

The data compare unit can be a minimum unit of read/write (512-byte sector) when the host computer accesses the storage subsystem 10, or a page which is the minimum access unit of the flash memory 165, and so on (for example, if the unit of comparing data is a sector, the new data and the old data are compared per unit (one sector). In that case, if all the data (all bits) within a unit (one sector) are the same when data of a unit (one sector) is compared, it is determined that the data in the single unit is identical, but if even one bit of data differs within a unit, it is determined that the data of the single unit does not coincide).

The present invention is effective regardless of the comparison unit being adopted, but at least according to the storage device (flash storage) 160 of an embodiment of the present invention, the comparison is performed in a unit having a smaller size than the data size of the fixed address range (such as a single stripe, or an integral multiple of stripes) transmitted from the storage controller 170 with a single compare write request. If the compare unit is the minimum unit (such as a single sector) of read/write when the host computer accesses the storage subsystem 10, the determination on whether the new data and the old data are equal or different can be performed in detail, so that there is an advantage that the improvement of the effect of reducing the number of rewrites of the flash memories 165 can be realized. Further, when the comparison unit is set to a page, which is the minimum unit of read/write of the flash memories 165 used as a storage media by the flash storage 160b, there is an advantage that the management of the storage areas within the flash storage 160b can be simplified.

Furthermore, since the update portion is specified by the result of comparison, the update portion specified by the flash storage 160b and the new data 1310 actually written by the host computer 30 do not necessarily coincide. Since it is possible that the new data 1310 actually written by the host computer 30 includes the same portions as the old data, it may be possible that the amount of data of the update portion specified by the flash storage 160b is smaller than the amount of data of the new data 1310 actually written by the host computer 30.

As a result of the comparison, only the new data 1630 in the area where values of the old data 1631 and the new data 1630 differ is stored in the flash memory 165 of the flash storage 160b. Thereby, out of the new data 1310 actually written by the host computer 30, only the portions that differ from the old data 1631 (1311) are stored into the flash memory 165, so that the number of writes to the flash memory 165 can be cut down.

Further, the flash storage 160b according to the present embodiment supports a write command (simply writing designated new data without comparing the new data and the old data) supported by the conventional storage devices such as HDDs and SSDs, other than the compare write request. In the following description, the write command supported by conventional storage devices such as HDDs and SSDs is called a “normal write request”.

When the flash storage 160b according to the embodiment of the present invention receives a normal write request from the storage controller 170, a process of simply storing the designated new data to the flash memory 165 will be performed, similar to the write process performed in a conventional storage device. Only when the compare write request is received from the storage controller 170, a process as described above is performed to store only the new data 1630 in the area where the values between the old data 1631 and the new data 1630 differ of the flash memory 165 into the flash storage 160b.

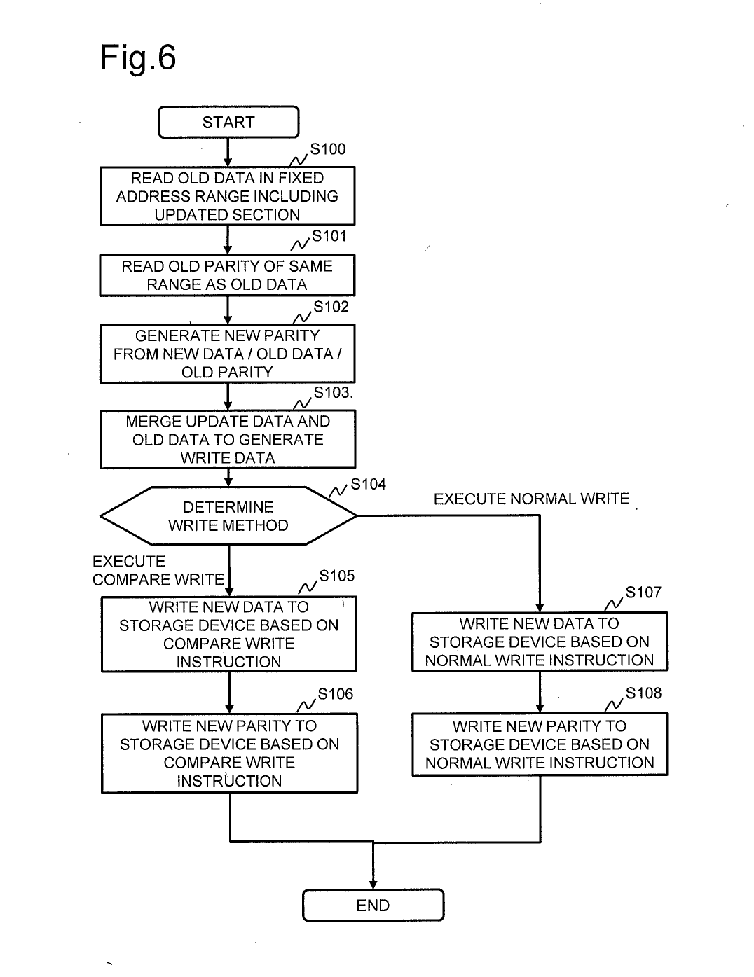

FIG. 6 is a flow diagram illustrating the process of a collective write program 1220 executed by the processor 121 of the storage controller 170. The collective write program 1220 operates to store the update portion of a fixed address range to the storage device 160 at an appropriate timing. The processes of the respective steps described below are performed by the processor 121 executing the collective write program 1220, unless defined otherwise.

Further, in the following description, we will describe the flow of the process performed when the storage controller 170 performs a collective write process of data (and parities corresponding to the data) to the storage device 160 constituting a RAID group. The description will mainly focus on a case where the RAID type (data redundancy method in a RAID technique) of the RAID group is RAID5.

At first, in step S100, old data of a fixed address range including an updated section (hereafter called a write target range) is read from the storage device 160 to the cache memory 131. Next, in step S101, the old parity corresponding to the data written in step S100 is read from the storage device 160 storing the parity so as to create redundant data (parity). Normally, the storage device 160 accessed in step S100 and the storage device 160 accessed in step S101 (storage device storing the parity) differ. Moreover, the address range (within the storage device) storing the old parity is the same as the address range (within the storage device) storing the old data corresponding to the old parity. However, depending on the RAID type of the RAID group, the address range storing the old parity may differ from the address range storing the old data, but the present invention is effective even in such case.

Next, in step S102, a new parity is generated using the old data read in step S100, the old parity read in step S101, and new data which is the update portion written from the host computer 30. The method for generating a new parity can be an XOR operation, or any other computation method guaranteeing redundancy.

In step S103, the old data read in step S100 and the update data written from the host computer 30 are merged to generate data to be written to the storage device 160. Next, in step S104, determination of the write method is performed. The determination of a write method can be performed, for example, to select the write method using a compare write when it is determined based on the compare write process function that the effect of reduction of the number of rewrites of the flash memory 165 is relatively high.

For example, compare write is executed when the write target storage device 160 is a storage device supporting a compare write process function, and that within the current write target range, there are two or more continuous areas being the write target (that is, when it includes at least one portion where update is not performed by the host computer 30), and if not, it executes a normal write. In order to determine whether the storage device supports the compare write process function or not, it is simply necessary to refer to the compare write support management table 1224.

It is also possible to use the status of load or the life of the storage controller 170 or the storage devices 160 as the basis of determining the write method. One example of a case where the load status or the life are used as the basis of determination will be described with reference to Embodiment 3.

Steps S105 and S106 are executed when it is determined in step S104 that compare write is to be used (execution of compare write). In step S105, the write data generated in step 103 using the compare write request is transferred to the storage devices 160. In step S106, the new parity generated in step S102 is transferred to the storage device 160 using the compare write request.

Step S107 is executed when it is determined in step S104 that normal write is to be executed. In step S107, the write data generated in step 103 using the normal write request is transferred to the storage device 160. In step S108, the new parity generated in step S102 using the normal write request is transferred to the storage device 160.

FIG. 6 has been described assuming that the RAID type of the RAID group is RAID5, but it can be other RAID types (such as RAID1 or RAID6). For example, in the case of RAID1, steps S101, S102, S106 and S108 which are processes for parity operation become unnecessary, and instead, step S105 (or step S107) will be performed multiple times for different storage devices 160. In the case of RAID6, in addition to the process of FIG. 6, a process required for generating and updating a second parity (so-called a Q parity) will be added.

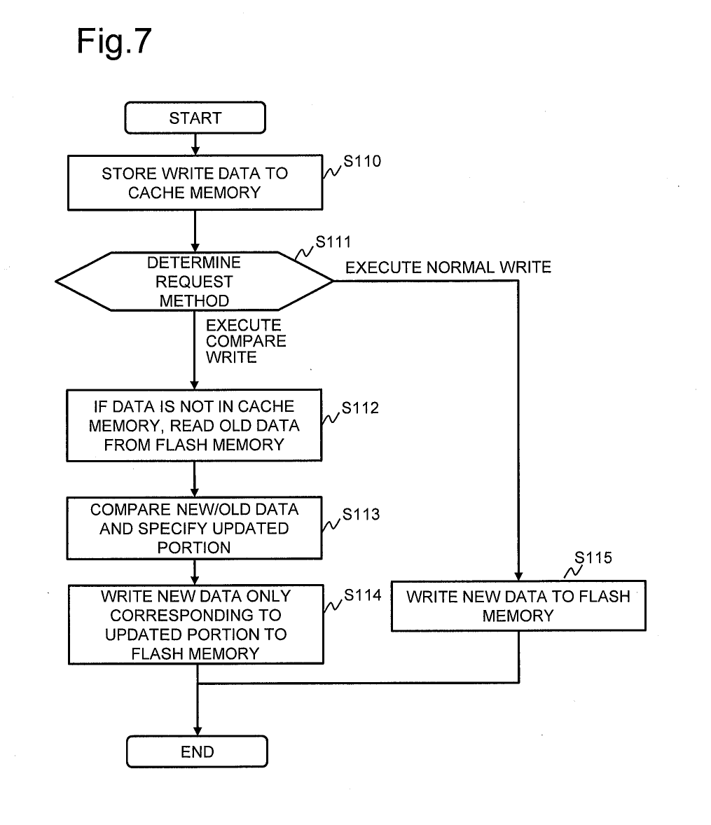

FIG. 7 is a flowchart illustrating the process of the compare write program 1622 of the flash storage 160b. The compare write program 1622 is operated when a compare write request or a normal write request is received from the storage controller 170. The processes of the respective steps described hereafter will be performed by the package processor 161 of the flash storage 160b executing the compare write program 1622, unless otherwise defined.

At first, in step S110, the write data is stored into the cache memory 163. Next, in step S111, the request method of the storage controller 170 will be determined. When the storage controller 170 issued the compare write request, step S112 is executed, and when the storage controller 170 issued the normal write request, step S115 is executed.

Next, in step S112, the old data corresponding to the new data received in step S110 is read from the flash memory 165 to the cache memory 163. If the old data already exists in the cache memory before the old data is read in step S112, there is no need to read the old data from the flash memory.

Next, in step S113, the new data received with the compare write request is compared with the old data read in step S112, and the update portions (the portions where the content differs between the new data and the old data) are specified. The comparison unit can be various units, but according to the flash storage 160b in the embodiment of the present invention, the comparison between new data and old data is performed per data having a smaller size (such as a sector or a page) than the data size of the fixed address range transmitted together with a single compare write request from the storage controller 170. Moreover, the comparison between the new data and the old data can be executed by the package processor 161, or a hardware dedicated for comparing data can be provided in the flash storage 160b, and the package processor 161 can have this hardware dedicated for comparing data perform data comparison. Lastly, in step S114, only the update portion specified in step S113 is stored in the flash memory 165.

In step S115, the write data received from the storage controller 170 in S110 is stored as it is in the flash memory 165.

Further, it is also possible to adopt a method to reduce the processing load of the flash storage 160b, by providing a function to designate (priority cache designation) from the exterior whether to leave the data remaining in the cache memory 163 with priority for each data read in the cache memory 163 of the flash storage 160b. If such function is provided to the flash storage 160b, the collective write program 1220 (or the processor 121 executing the program) can designate (priority cache designation) to the flash storage 160b so as to leave the data read to the cache memory 163 in the flash storage 160b remaining with priority in step S100 (or step S101) when reading the old data in step S100 of FIG. 6 (when reading the old parity in step S101). By performing a priority cache designation, there will be no need to read the old data/old parity from the flash memory 165 to the cache memory 163 in step S112, so that the processing load of the flash storage 160b can be reduced. Further, the processor 121 can issue a cancellation request explicitly regarding the priority cache designation, or the flash storage 160b can voluntarily cancel the designation after the flash storage 160b uses the old data remaining in the cache memory 163 in step S113.

The timing for retuning a completion response of the compare write request to the storage controller 170 can either be immediately after step S110 when the flash storage 160b stores the write data received from the storage controller 170 to the cache memory 163, or can be after the completion of the process of FIG. 7.

In the above description, an example has been illustrated where the storage controller 170 determines the write method in step S104 of FIG. 6, but it is also possible to determine the write method in the flash storage 160b. For example, the processor 121 of the storage controller 170 will not perform step S104 of FIG. 6, but issues a normal write request to the flash storage 160b unconditionally. The flash storage 160b having received the write request performs the write method determination instead of the request method determination of step S111. The method of determining the write request can be, for example, a method of managing the load status of the flash storage 160b, and if the load is higher than a given threshold, selecting a normal write method, but if the load is lower (than a given threshold), selecting a compare write method.

### Embodiment 2

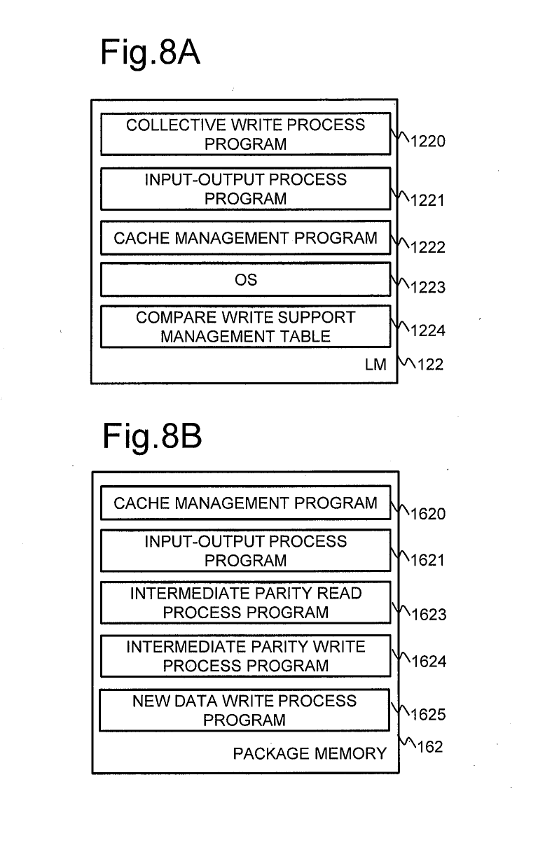

Embodiment 2 of the present invention will be described with reference to FIGS. 8 through 11. The configuration of the storage subsystem 10 according to Embodiment 2 is the same as that of the storage subsystem 10 according to Embodiment 1 described with reference to FIG. 1, so it will not be illustrated. The storage device 160 according to Embodiment 2 differs from the storage device 160 of Embodiment 1 in that it has a function to assist parity operation. Other points are the same as those illustrated in Embodiment 1. The function for assisting parity operation can be realized by a program executed by the package processor 161, or can adopt a configuration for implementing dedicated hardware for performing parity operation, such as an ASIC. In Embodiment 2, a configuration is illustrated using the flash storage 160b having a function to assist parity operation. Only the differences with Embodiment 1 are illustrated below.

At first, the outline of the function for assisting parity operation provided to the storage devices 160 will be described. The function for assisting parity operation is an art disclosed for example in United States Patent Application Publication 2013/0290773, wherein the storage devices 160 has a function for generating an exclusive OR (XOR) of data before update of the write data and the write data, or the function for transmitting the generated XOR operation result to the exterior are provided.

The outline of the method for generating a parity of the storage subsystem 10 using the storage device 160 with a function for assisting parity operation will be described below. In order to update data of the storage device 160 constituting the RAID group, the storage controller transmits the update data together with the new data transmission request to the storage device 160 storing the data before update of the relevant update data. When the storage device 160 receives the new data transmission request, it stores the update data in the storage device. However, the data before update corresponding to the update data is also retained in the storage device. The reason for this is because the data becomes necessary in generating an intermediate parity described later.

Thereafter, the storage controller issues an intermediate parity read request to the relevant storage device 160. When the storage device 160 receives the intermediate parity read request, it calculates an intermediate parity from the update data and the data before update, and returns the calculated intermediate parity to the storage controller. The method for calculating the intermediate parity can adopt an XOR operation, for example.

The storage controller 170 transmits the intermediate parity together with the intermediate parity write request to the storage device 160 storing the parity. When the storage device 160 storing the parity receives the intermediate parity write request, it generates a parity after update based on an intermediate parity having been received by a former request and a parity before update, and stores the same in its own storage device. At this point of time, the intermediate parity and the parity before update are retained.

Lastly, the storage controller issues a purge (commit) request to the storage device 160 storing the update data and the storage device 160 storing the parity. When the storage device 160 storing the parity receives a commit request, it discards the intermediate parity having been received by a previous request and the parity before update, and determines the parity after update as formal data. Further, the storage device 160 storing the update data discards the data before update, and determines the data after update as formal data.

FIG. 8A illustrates an example of programs and control information stored in the LM 122 of the storage controller 170 according to Embodiment 2. The LM 122 stores the collective write process program 1220, the input-output process program 1221, the cache management program 1222, the OS 1223 and the compare write support management table 1224. The compare write support management table 1224 can be stored in the SM 132, the CM 131, or the storage devices 160.

FIG. 8B illustrates an example of programs and controls information stored in the package memory 162 within the flash storage 160b according to Embodiment 2. The package memory 162 stores the cache management program 1620, the input-output process program 1621, an intermediate parity read process program 1623, an intermediate parity write process program 1624, and a new data write process program 1625.

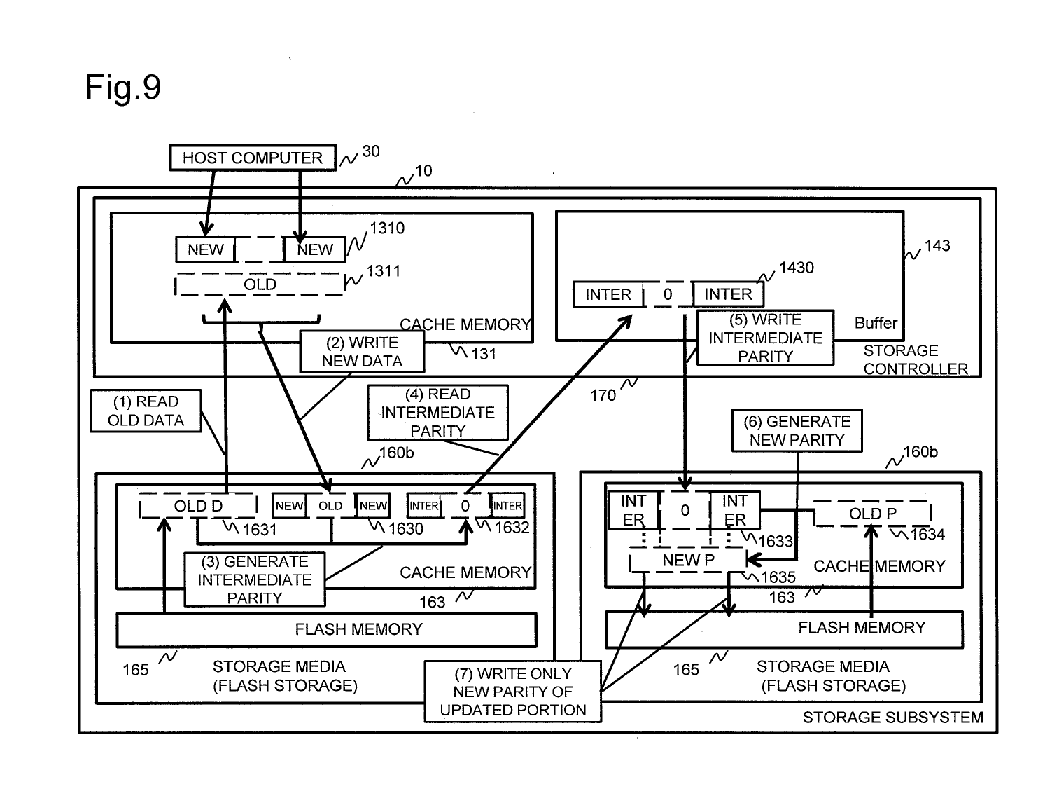

The outline of Embodiment 2 will be described with reference to FIG. 9. In the following description, we will describe the flow of the process performed by the storage controller 170 for performing a collective write process of data (and parity corresponding to the relevant data) of the storage devices 160 constituting a RAID group. We will mainly describe a case where the RAID type of the relevant RAID group (data redundancy method in the RAID technique) is RAID5, where the parity generated by performing an XOR operation is stored in a single storage device 160.

Embodiment 2 is composed of a storage subsystem 10 and a host computer 30 issuing the I/O. The storage subsystem 10 includes a storage controller 170 having a cache memory 131 and a buffer 143, a first flash storage 160b storing user data (write data received from the host computer 30), and a second flash storage 160b storing the parity corresponding to the user data. Each flash storage 160b includes a cache memory 163 and a flash memory 165. The new data 1310 written from the host and the old data 1311 read from the flash storage 160b are stored in the cache memory 131 of the storage controller 170. An intermediate parity 1430 read from the flash storage 160b is stored in the buffer 143 of the storage controller 170.

The flash storage 160b includes the cache memory 163 and the flash memory 165, and the new data 1630 written from the host computer 30 and the old data 1631 read from the flash memory, and an intermediate parity 1632 generated from the old data 1631 and the new data 1630 are stored in the cache memory 163 of the first flash storage 160b. An intermediate parity 1633 written from the storage controller 170 and an old parity 1634 read from the flash memory, and a new parity 1635 generated from the intermediate parity 1633 and the old parity 1634 are stored in the cache memory 163 of the second flash storage 160b.

According to the flash storage 160b of Embodiment 2 in the present invention, in addition to the function for assisting the parity operation described at the beginning (the new data transmission request, the intermediate parity read request, the intermediate parity write request, and the commit request), the following commands are supported: a compare new data transmission request, and a compare intermediate parity write request. We will describe the operation of the flash storage 160b having received these commands in the following description.

The host computer 30 transmits a write request and a write data accompanying the write request to the storage subsystem 10. The storage controller 170 within the storage subsystem 10 writes the write data to be stored in the fixed address range collectively to the flash storage 160b (collective write). Therefore, multiple sections of update portions exist in the fixed address range. In FIG. 9, there are two updated sections, but it is possible to have three or more updated sections included therein.

The storage controller 170 reads the old data 1311 from the first flash storage 160b in order to complement the data in the area where there has been no update from the host computer 30 within the fixed address range, and stores the same in the cache memory 131. The storage controller 170 merges the new data 1310 and the old data 1311 written from the host 30, and sends the compare new data transmission request to the first flash storage 160b. An area of the new data 1310 updated through host write and an area of the old data 1311 read from the flash storage 160b exist in a mixture in the new data 1630 written to the flash storage 160b. Further, the address range information of write target data is included in the compare new data transmission request, similar to the compare write request described in Embodiment 1.

The first flash storage 160b having received the compare new data transmission request compares the old data 1631 stored in the first flash storage 160b and the new data 1630 received by the compare new data transmission request, and specifies the updated portion. The unit of comparison of data can adopt any arbitrary unit, similar to Embodiment 1. Since the update portion can be specified based on the comparison result, the update portion determined by the flash storage 160b and the new data 1310 actually written by the host computer 30 do not necessarily coincide.

As a result of the comparison, only the new data 1630 of the area where the values between the old data 1631 and the new data 1630 differ is stored in the flash memory 165 within the flash storage 160b. Of the new data 1310 actually written by the host computer 30, only the portion that differs from the old data 1631 (1311) is stored in the flash memory 165, so that the number of times of writes to the flash memory 165 can be reduced. Until the purge (commit) request described later is received, not only the new data 1630 but also the old data 1631 are left remaining in the flash storage 160b as valid data. This is because the old data 1631 is required to generate an intermediate parity. The location in which the old data 1631 is left can be the flash memory 165 or the cache memory 163.

Next, the storage controller 170 issues an intermediate parity read request to the first flash storage 160b, and stores the intermediate parity 1430 read from the first flash storage 160b to the buffer 143. An example has been illustrated where the data is stored in the buffer 143, but it can also be stored in a different area, as long as the area can retain the information until it is written in the second flash storage 160b.

The first flash storage 160b having received the intermediate parity read request generates the intermediate parity 1632 from the new data 1630 and the old data 1631, and transfers the intermediate parity 1632 to the storage controller 170. Here, an example has been described where the first flash storage 160b generates the intermediate parity 1632 during the intermediate parity read request, but it is also possible to generate the same when a compare new data is transmitted, or asynchronously as the command received from the storage controller 170 (such as at an arbitrary timing from when the compare new data transmission request has been issued to when an intermediate parity read is performed).

Next, the storage controller 170 issues the compare intermediate parity write request to write the intermediate parity 1430 to the second flash storage 160b. An address range information of the old parity corresponding to the intermediate parity 1430 is included in the compare intermediate parity write request.

The second flash storage 160b having received the compare intermediate parity write request generates a new parity 1635 from the old parity 1634 stored in the second flash storage 160b and the intermediate parity 1633 written to the storage controller 170. Next, the second flash storage 160b only stores the new parity 1635 corresponding to the area where the intermediate parity 1633 is not “0” to the flash memory 165. The unit for specifying the new parity 1635 corresponding to the area where the intermediate parity 1633 is not “0” can be any arbitrary unit (such as a sector unit or a page unit), similar to the unit of comparison of data described in Embodiment 1. For example, it is possible to specify the new parity 1635 corresponding to the area where the intermediate parity 1633 is not “0” in sector units.

The parity operation of RAID5 uses an XOR operation, and the update portion is specified by utilizing the property that the XOR operation result of the areas having the same values become 0. When parity calculation methods other than the XOR operation is adopted, the update portion can be specified by comparing the new parity 1635 generated in the second flash storage 160b and the old parity 1634 stored in the second flash storage 160b. By storing only the update portions in the flash memory 165, it becomes possible to reduce the number of writes to the flash memory 165.

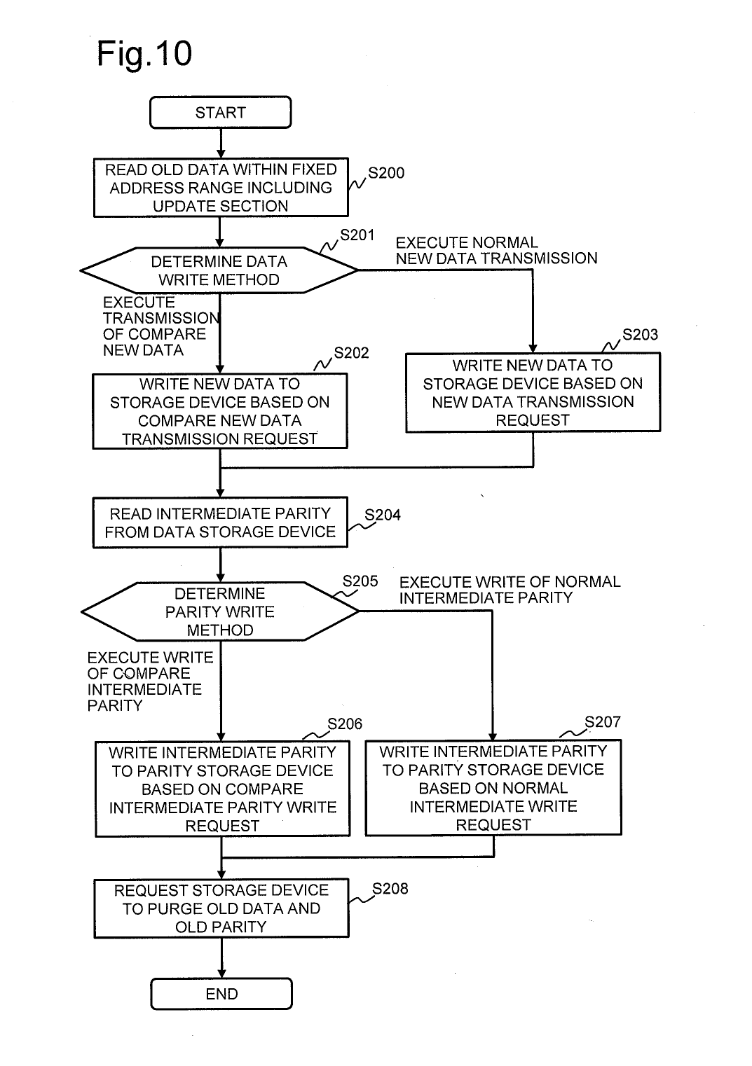

FIG. 10 is a flowchart illustrating a process performed by the collective write program 1220 of the storage controller 170. The collective write program 1220 operates to store the update portion within a fixed address range to the storage device 160 at an appropriate timing. The processes of the steps described below are performed by the processor 121 executing the collective write program 1220, unless stated otherwise. Each storage device 160 has a function to assist the parity operation described at the beginning of Embodiment 2, but it is assumed that only the flash storages 160b have the function for storing only the update portions, such as the compare new data write request, and the other storage devices 160 do not have the function for storing only the update portions.

At first, in step S200, the old data of the fixed address range including the update section is read from the storage device 160 to the cache memory 131. Next, in step S201, the data write method is determined. The determination of the data write method can use the same method as the method described in Embodiment 1.

Step S202 is executed when it is determined in step S201 that the compare new data transmission request should be used. In step S202, the old data read into the cache memory 131 in step S200 is merged with the new data written from the host, and the data having merged the old data is written to the first storage device 160 storing the data by issuing the compare new data transmission request. Step S203 is executed when it is determined in step S201 that a normal new data transmission request should be used. In step S203, the old data read into the cache memory 131 in step S200 is merged with the new data written from the host, and the data having merged the old data is written to the first storage device 160 storing the data by issuing a normal new data transmission request.

In step S204, the intermediate parity read request is issued to the first storage device 160 storing data, and the intermediate parity is read. Thereafter, in step S205, the determination of the parity write method is performed. The method for determining the write method is performed similarly as step S201, and if it is determined that it is more preferable to perform the compare intermediate parity write request, step S206 is executed, and if not, step S207 is executed.

In step S206, the intermediate parity read in step S204 is written to the second storage device 160 storing the parity by transmitting the same together with the compare intermediate parity write request to the second storage device 160 storing the parity. In step S207, the intermediate parity is transmitted together with a normal intermediate parity write request to the second storage device 160 storing the intermediate parity read in step S204.

Lastly, in step S208, a commit (purge) request of old data and old parity is issued to the first storage device 160 storing the old data and the second storage device 160 storing the old parity. The first storage device 160 having received the commit (purge) request discards the old data, and the second storage device 160 having received the same discards the intermediate parity and the old parity.

FIG. 10 has been illustrated assuming that the RAID is RAID5, but other RAID types (such as RAID6) can also be adopted. For example, in the case of RAID6, a process required for generating and updating the second parity is added to the process illustrated in FIG. 10.

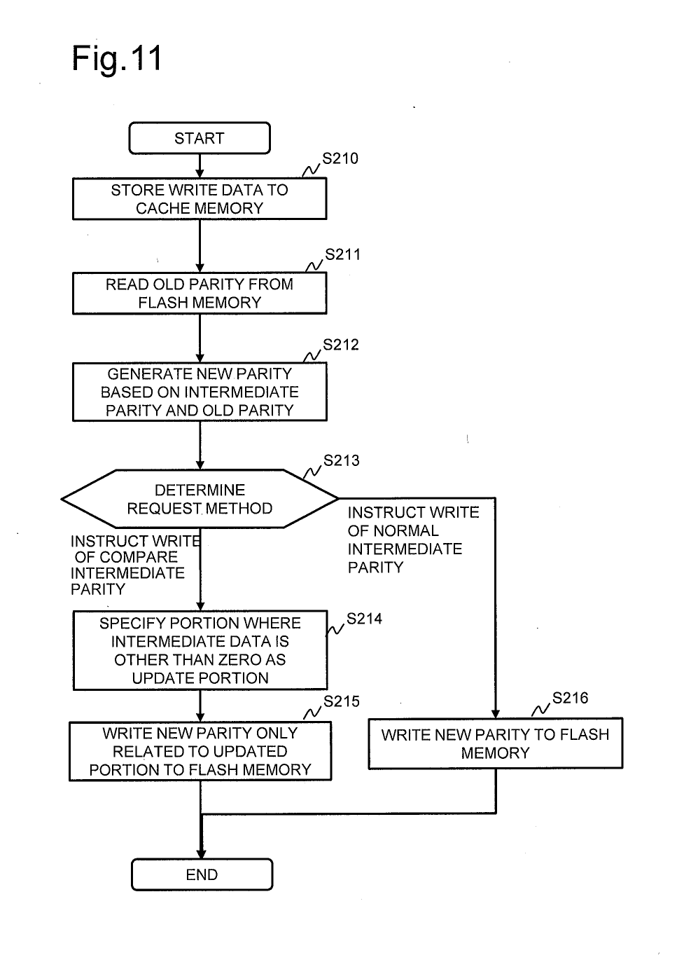

FIG. 11 is a flowchart illustrating an intermediate parity write program 1624 of the flash storage 160b. The intermediate parity write program 1624 is activated when an intermediate parity write request (compare intermediate parity write request or normal intermediate parity write request) is received from the storage controller 170. The processes of the respective steps described hereafter are performed by the package processor 161 of the flash storage 160b by executing the intermediate parity write program 1624, unless stated otherwise.

At first, in step S210, the write data (more accurately, the intermediate parity data) is stored in the cache memory 163. Thereafter, in step S211, the old parity is read from the flash memory 165 to the cache memory 163.

Next, in step S212, a new parity is generated from the old parity read in step S211 and the intermediate parity written from the storage controller 170 in step S210. In FIG. 11, a method has been described where all parities in the written range are generated, but it is also possible to specify the update portion equivalent to step S214 (described later) before step S210, and generate a new parity only for the update portions.

Thereafter, in step S213, the request method of the storage controller 170 is determined. When the storage controller 170 has issued the compare intermediate parity write request, steps S214 and S215 are performed, but when the storage controller 170 has issued a normal intermediate parity write request, then step S216 is performed.

In step S214, the value of the intermediate parity is confirmed, and the area having a value “other than 0” is specified as the update portion. This is a process for specifying the update portion using the characteristics of the XOR operation, as described in FIG. 9, and if a calculation method other than the XOR operation is to be utilized, a method for specifying the update portion corresponding to the method can be used. Further, if the update portion cannot be determined merely by confirming the value of the intermediate parity, then the update portion can be specified by comparing the new parity and the old parity. Lastly, in step S215, only the area of the new data corresponding to the update portion specified in step S214 is stored in the flash memory 165, and the process is ended.

In step S215, the created new parity is stored to the flash memory 165, and the process is ended.

In FIG. 10, when reading the old data of step S200, as described in Embodiment 1, it is possible for the storage controller 170 to designate the flash storage 160b to leave the data read into the cache memory 163 of the flash storage 160b remain with priority (priority cache designation). By performing the priority cache designation, there is no need to read the old data from the flash memory 165 to the cache memory 163 in the flash storage 160b having received step S202, so that the process load of the flash storage 160b can be reduced. Further, regarding the priority cache designation, the storage controller 170 can issue a cancellation request explicitly, or the flash storage 160b can cancel the same in synchronization with the reception of a command (purge request) that can be determined as the end of the sequential process as in step S208, or the flash storage 160b can cancel the same after it has been used in the flash storage 160b.

Further, the timing in which the flash storage 160b returns an intermediate parity write request to the storage controller 170 can be immediately after step S210 for storing write data to the cache memory 163, or can be after the end of the above series of process.

In Embodiment 2, an example has been illustrated where the storage controller 170 determines the write method in step S201 and step S205 of FIG. 10, but the write method can also be determined by the flash storage 160b. For example, the storage controller 170 instructs the flash storage 160b to write the new data and the intermediate parity by issuing a normal write request (new data transmission request, intermediate parity write request) unconditionally, without performing steps S201 and S205 of FIG. 10. The flash storage 160b having received the write request performs determination of the write method in place of the determination of the request method of step S213. One example of the method for determining the write method manages the load status of the flash storage 160b, wherein if the load is high, a normal write method is selected, and if the load is low, a compare write method is selected.

A new data write program 1625 in the flash storage 160b is similar to the compare write program 1622 (FIG. 7) described with reference to Embodiment 1. However, as mentioned earlier, the present process differs from the process executed in the compare write program 1622 in that by having the new data write program 1625 executed, the old data is managed without being discarded so that an intermediate parity can be created even after the new data has been stored (old data and new data are mapped and managed, so that when an intermediate parity read request arrives, the old data and the new data are set to a readable state). Then, when the flash storage 160b receives a purge (commit) request, it discards the old data (when the flash storage 160b storing the parity receives a purge (commit) request, it deletes the old parity and the intermediate parity).

The flow of the process performed when the flash storage 160b receives the intermediate parity read request and the purge (commit) request is similar to that disclosed, for example, in United States Patent Application Publication No. 2013/0290773, so the description thereof will be omitted.

Further, an example has been described in Embodiment 2 where the update portions are specified by the flash storage 160b, but it can also be combined with a method as described in Embodiment 4 (described later) where the storage controller 170 designates the update positions using the bitmap or other information.

### Embodiment 3

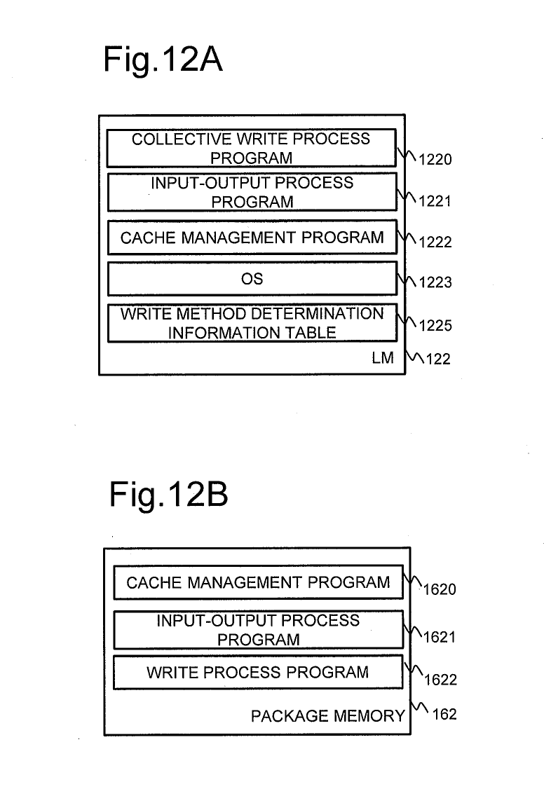

Embodiment 3 of the present invention will be described with reference to FIGS. 12 through 15.

In Embodiment 3, an example is illustrated where the determination is performed by considering information of the load status of the system or the life of the flash storage 160b, instead of using information of the updated sections or whether the compare write process function is supported or not, such as in Embodiments 1 or 2. Embodiment 3 illustrates an example where the determination of the write method and a write method determination information table 1225 retaining information on the determination of the write method are stored in the storage controller 170, but the similar determination and information can be retained in the flash storage 160b and the determination of the write method can be performed in the flash storage 160b. In another example, it is possible to perform the determination of the write method and to retain the write method determination information table 1225 in both the storage controller 170 and the flash storage 160b, so that the storage controller 170 and the flash storage 160b can each determine the write method.

In Embodiment 3, the only portions that differ from Embodiment 1 are described.

FIG. 12A illustrates an example of programs and control information stored in the LM 122 of the storage controller 170 according to Embodiment 3. The LM 122 stores the collective write process program 1220, the input-output process program 1221, the cache management program 1222, the OS 1223, and the write method determination information table 1225. The write method determination information table 1225 can be stored in the SM 132, or in the CM 131, or in the storage device 160.

FIG. 12B illustrates an example of programs and control information stored in the package memory 162 of the flash storage 160b according to Embodiment 3. The package memory 162 stores the cache management program 1620, the input-output process program 1621, and the compare write program 1622.

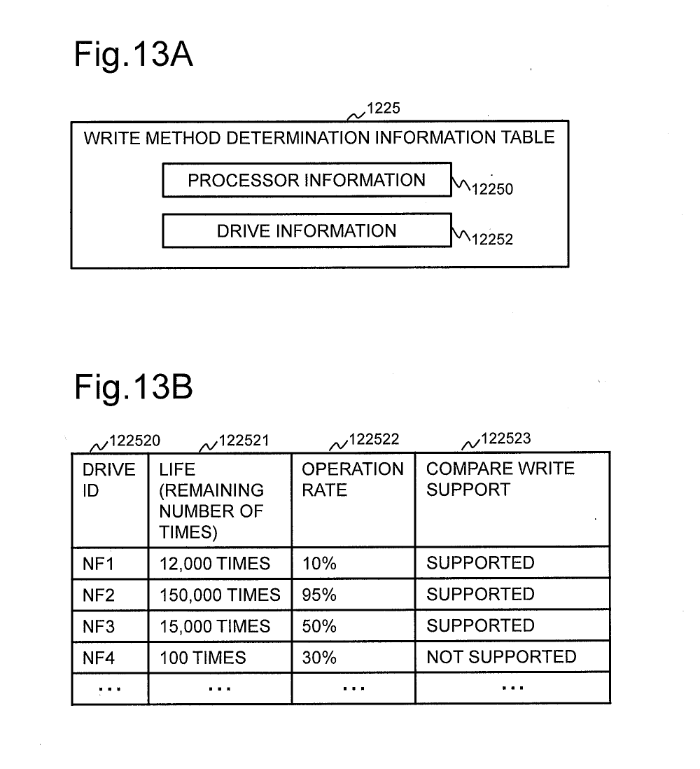

FIG. 13A illustrates a configuration example of the write method determination information table 1225 according to Embodiment 3. The write method determination information table 1225 stores a processor information entry 12250 and a drive information entry 12252. An average operation rate of the processor is stored in the processor information entry 12250. Operation information of the storage devices 160 (drives) or the like are stored in the drive information entry 12252. The details of the drive information entry 12252 will be described with reference to FIG. 13B.

In Embodiment 3, only a single average operation rate of the processor is retained in the storage subsystem 10, but it is also possible to manage the operation rates of respective processors, and to use the information corresponding to the processor in which processing is to be performed for the determination. Further, in addition to the processor information and the drive information, it is also possible to consider information indicating the status of the storage subsystem 10, such as the cache information or the pass information. For example, it is possible to use the amount of data in the cache and not written in the storage device 160 (dirty data) for predicting the drive load (such as determining that the drive load is high if the amount of dirty data is high). Furthermore, whether a method for sending only the update portions as described later in Embodiment 4 can be executed or not can be determined using the information on the path load between the storage controller 170 and the storage device 160.

FIG. 13B illustrates a configuration example of the drive information entry 12252 within the write method determination information table 1225. The drive information entry 12252 includes a drive ID column 122520, a life (remaining number of times) column 122521, an operation rate column 122522, and a compare write support existence column 122523.

The drive ID column 122520 stores an identifier for independently identifying the storage device 160 connected to the storage controller 170. The life (remaining number of times) column 122521 stores the life of the storage devices 160. The number of times of write is determined for the storage device 160 using a flash memory, and the life (remaining number of times) of the storage device 160 refers to the remaining number of times of writes (number of times of rewrites) that can be performed to the target storage device. The life of the storage devices 160 can be recognized by periodically acquiring the information related to the life from the storage devices 160, or by acquiring the information from the storage devices 160 at the timing of connection to the storage subsystem 10, and thereafter, counting the number of writes at the storage controller and determining the value to be stored in the life (remaining number of times) column 122521 based on the information.

The operation rate column 122522 stores the operation rate of the storage devices 160. The operation rate of the storage devices 160 can be acquired periodically from the storage devices 160, or can be computed based on the number (frequency) of input-output requests issued by the storage controller 170 to the respective storage devices 160. The compare write support existence column 122523 stores whether the storage device supports a compare write process or not. If the storage device 160 supports the compare write process, “supported” is stored therein, and if the storage device 160 does not support the compare write process, “not supported” is stored therein. The drive information entry can include information showing the features and states of the drives, such as the page size of the storage device 160, in addition to the information shown in FIG. 13B.

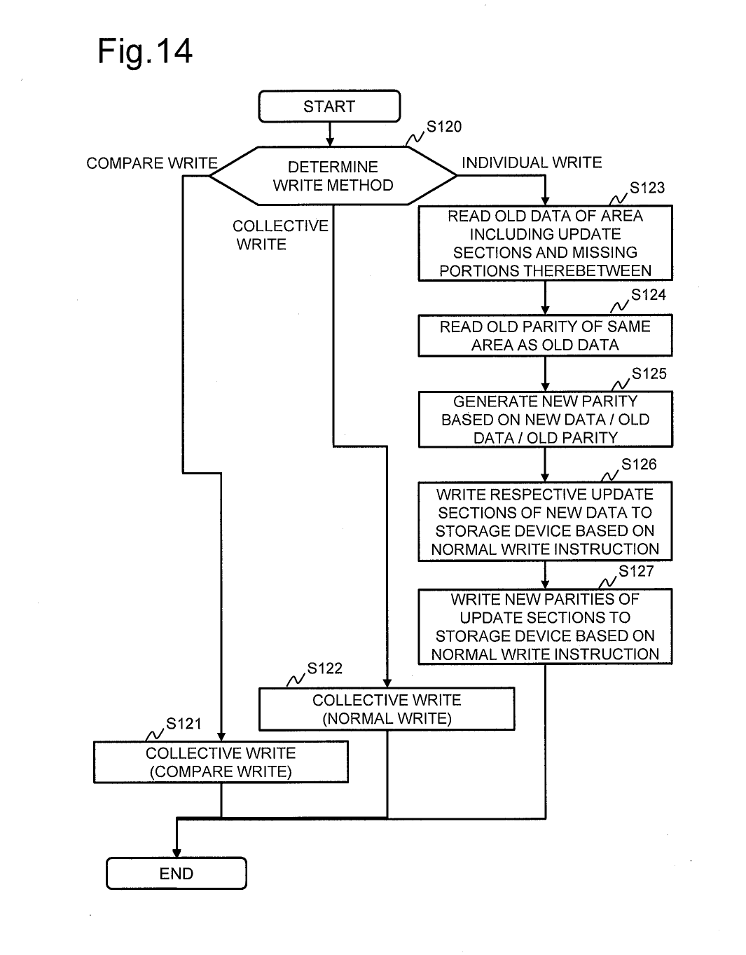

FIG. 14 is a flowchart illustrating the collective write program 1220 of the storage controller 170. The collective write program 1220 operates to store the update portion within the fixed address range to the storage device 160 at an appropriate timing. Unless stated otherwise, the processes of the respective steps described hereafter are performed by the processor 121 executing the collective write program 1220.

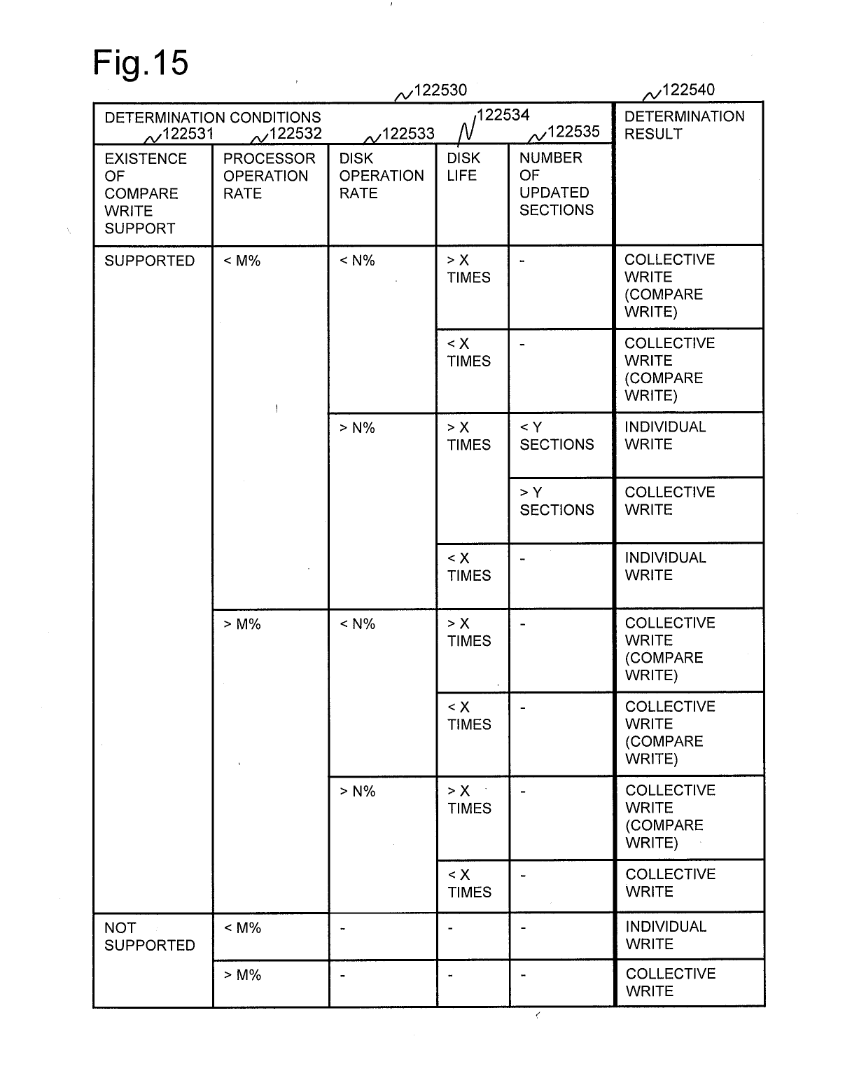

At first, in step S120, the write method is determined based on the write method determination information table 1225. The details of the determination of write method will be described later with reference to FIG. 15. Step S121 is executed when it is determined by the determination of the write method that it is a compare write, step S122 is executed when it is determined that it is a collective write, and step S123 is executed when it is determined that it is an individual write.

Step S121 executes the same process as when compare write has been determined in FIG. 6.

In step S123, the old data of the fixed address range including the updated section is read from the storage device 160 to the cache memory 131. Next, in step S124, the old parity corresponding to the old data is read from the storage device 160. Next, in step S125, a new parity is generated based on new data, old data and old parity. Thereafter, in step S126, the update sections of new data are respectively individually written to the storage devices 160 based on a normal write instruction. Next, in step S127, parities corresponding to the updated sections are individually written to the storage devices 160 based on a normal write instruction.

FIG. 15 is a view illustrating the examples of the basis for determining the write method by the storage controller 170 in a table format (write method determination reference table).

The write method determination reference table includes a determination condition column 122530 and a determination result column 122540. The determination condition column 122530 shows the combination of the respective determination conditions. FIG. 15 includes, in the determination condition column 122530, an existence of compare write support 122531, a processor operation rate 122532, a disk operation rate 122533, a disk life 122534, and number of updated sections 122535.

According to the condition of the existence of compare write support 122531, the entry corresponding to the storage device 160 of the compare write support column 122523 in the write method determination information table 1225 is referred to, wherein when the target storage device 160 supports compare write, “supported” is determined, and when the target device does not support compare write, “not supported” is determined.

According to the condition of the processor operation rate 122532, the processor information 12250 of the write method determination information table 1225 is referred to, and whether the operation rate of the MP 121 of the storage controller 170 exceeds M % or not is determined.

According to the condition of the disk operation rate 122533, the entry corresponding to the storage device 160 of the operation rate column 12252 of the write method determination information table 1225 is referred to, and whether the operation rate of the storage device 160 has exceeded N % or not is determined. According to the condition of the disk life 122534, the entry corresponding to the storage device 160 of the life column 122521 of the write method determination information table 1225 is referred to, and whether the life of the storage device 160 is greater than X times or not is determined.

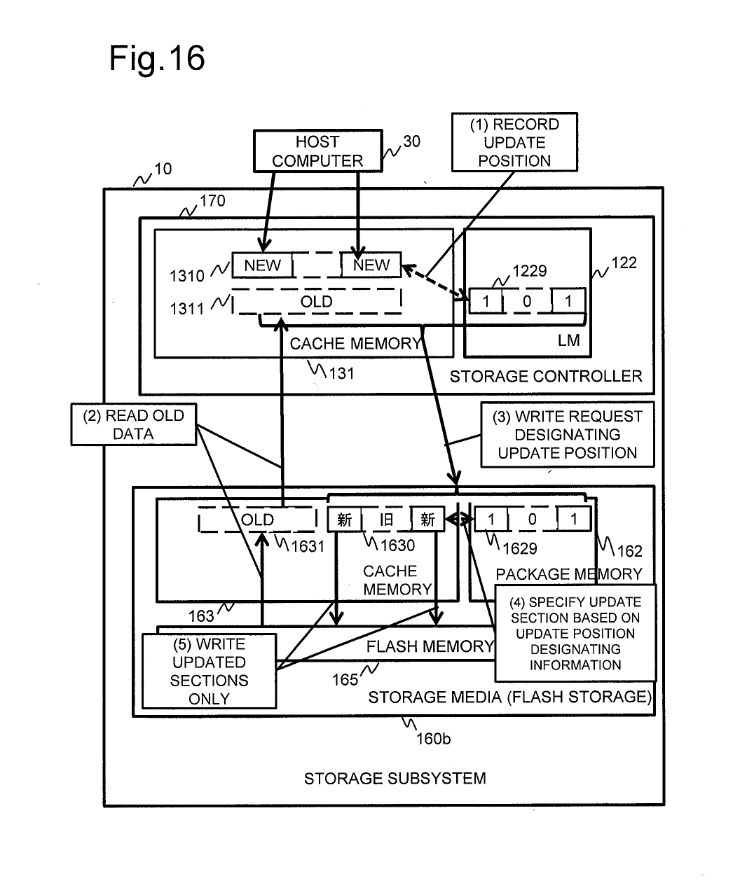

According to the condition of the number of updated sections 122535, it is determined whether the number of updated sections within the write rate is greater than Y or not. The number of updated sections within the write range is the number of areas of update portions having continuous addresses included in the write range, and one updated section is separated from another update section by a non-updated section. For example, the number of updated sections is two in the case of the new data 1310 of FIG. 16.

The threshold values of the conditions, such as M %, N %, X number of times and Y sections, can be set to a fixed value, or the storage administrator can set the values by providing the setup method via a management screen such as a GUI, or can be set to be varied dynamically by the combination with other conditions. Further, multiple number of threshold values can be used for determining the condition.

Based on the respective conditions of the determination condition column 122530, a determination result 122540 is determined by other conditions, and if a certain determination condition is not relevant, “-” is entered.

Other than the information stored in FIG. 15, it is possible to use the information on whether or not old data used for comparison is remaining in the cache memory 163 of the storage device 160, or whether or not the data is a random write data or sequential write data, or other data related to write data. Further, other than using all information shown in FIG. 15 for determination, it is possible to use only a portion of the information shown in FIG. 15 for determination. For example, it is possible to adopt a method for using either the disk operation rate 122533 or the disk life 122534 for determination, instead of using both the disk operation rate 122533 and the disk life 122534 for determination.

The determination result column 122540 shows the write method to be executed when combining the respective determination results. When the storage controller 170 should perform write to the storage devices 160 based on a compare write instruction, “collective write (compare write)” is set thereto. When the storage controller 170 should perform write to the storage device 160 based on a normal write instruction, “collective write” is set thereto. When the storage controller 170 should divide the write range per updated section and perform write of the respective updated sections based on a normal write instruction to the storage devices 160, individual write is set thereto.

### Embodiment 4

Embodiment 4 of the present invention will be described with reference to FIGS. 16 through 19.

Embodiment 4 illustrates an example where the storage controller 170 notifies a bitmap illustrating the update position together with the write data as information for specifying the update data position. In the present embodiment, bitmap is used as information designating the update position, but other information capable of designating the update position, such as the list of information showing the start address and the end address, can be used instead. Only the difference between the present embodiment and Embodiment 1 will be described.

FIG. 16 is an explanatory view illustrating the outline of Embodiment 4. The system includes a storage subsystem 10 and a host computer 30 issuing I/Os. A storage controller 170 and a flash storage 160b are disposed in the storage subsystem 10. A cache memory 131 and an LM 122 are disposed in the storage controller.

New data 1310 written by the host computer 30 or the old data 1311 read from the flash storage 160b are stored in the cache memory 131. An update bitmap 1229 showing the update position of new data 1310 is stored in the LM 122. The update bitmap 1229 can be stored in the cache memory 131, the shared memory 132, or any area capable of being accessed by the storage controller 170.

The flash storage 160b includes a cache memory 163, a package memory 162 and a flash memory 165. New data 1630 written from the storage controller 170 and old data 1631 read from the flash memory 165 are stored in the cache memory 163. An update bitmap 1629 transferred from the storage controller 170 together with the new data 1630 is stored in the package memory 162. The update bitmap 1229 can be stored in the cache memory 163, or can be stored in any other area that can be accessed from the package processor 161 of the flash storage 160b.

The host computer 30 transmits the write request and the write data accompanying the write request to the storage subsystem 10. The storage controller 170 having received the write request from the host computer stores the update position in the update bitmap 1229 of the LM 122. The storage subsystem 10 normally has information (dirty bitmap) for specifying the area storing the data not yet reflected in the flash storage 160b from the area within the cache memory 131. When the storage subsystem 10 stores the write data from the host computer 30 to the cache memory 131, the bit of the dirty bitmap corresponding to the area in the cache memory 131 storing the write data is turned ON. The storage subsystem 10 according to the present embodiment generates the update bitmap 1229 based on the dirty bitmap when performing an update position designating write. However, as another embodiment, the dirty bitmap can be used as it is as the update position designating bitmap 1229. In another example, the update designating bitmap 1229 can be managed regardless of the dirty bit.

The storage controller 170 within the storage subsystem writes the write data to be stored in the fixed address range collectively to the flash storage 160b (collective write). Therefore, multiple updated sections exist within the fixed address range. In FIG. 16, there are two updated sections, but it can include three or more updated sections.

In order to complement the data of the area not updated by the host computer 30 within the fixed address range, the storage controller 170 reads the old data 1311 from the flash storage 160b. The storage controller 170 generates the update bitmap 1229 from the dirty bitmap. The storage controller 170 merges the new data 1310 written from the host 30 and the old data 1311 read from the flash storage 160b, and outputs an update position designating write request to the flash storage 160b together with the update bitmap 1229. Since the storage controller 170 merges the new data 1310 and the old data 1311 and transfers the same to the new data 1630 written to the flash storage 160b, there exist areas of the new data 1310 updated by the host write request and areas of the old data 1311 read from the flash storage 160b.

The flash storage 160b having received the update position designating write request stores the new data 1630 in the cache memory 163 and the update bitmap 1629 in the package memory 162. The flash storage 160b refers to the update bitmap 1629 to specify the updated section of the new data 1630, and stores only the update section of the new data 1630 to the flash memory 165. The update position designating write request includes the information on the write destination address range in the flash storage 160b of the write target data, similar to the normal write request, and more precisely, the flash storage 160b uses the information of the update bitmap 1229 and the write destination address range to specify the update position (address) of the new data 1630.

In FIG. 16, a method for reading old data from the flash storage 160b has been illustrated as a method for complementing the non-update portion of the area updated by the host computer 30, but instead of the method of reading old data, it is possible to adopt a method where the storage controller 170 generates dummy data, and the host computer 30 complements the non-update portions between the updated regions using the dummy data.

Some storage subsystems have a function for assigning a guarantee code for confirming the validity of data to the respective units (512-byte sectors) of data stored in the storage devices 160, and a function for performing data inspection using the guarantee code. In the storage subsystem 10 according to Embodiment 4, if a function performing data inspection using the guarantee code is provided to the flash storage 160b, the storage controller 170 can intentionally generate and add an erroneous guarantee code as the guarantee code of the dummy data when generating dummy data as the data for the non-update portion, so as to prevent the dummy data having the intentionally erroneous guarantee code added thereto from being written to the storage media (flash memory 165) in the flash storage 160b. Thereby, even if the contents of the update bitmap 1229 are erroneous, it is possible to prevent the writing of the non-update portion by the flash storage 160b. By preventing the writing of the non-update portion by the flash storage 160b, it becomes possible to prevent the user data from being destroyed by having the dummy data overwritten thereto, when the update bitmap 1229 is erroneous.

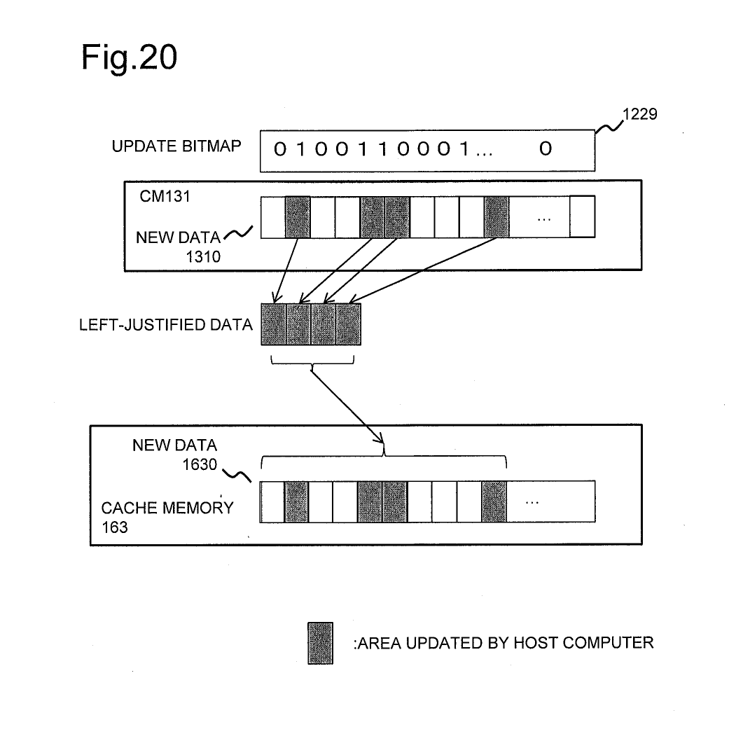

Further, it is possible to adopt a method where the storage controller 170 generates a packed data excluding the non-updated portion of the new data 1310 (packed data), and transfers the same together with the update bitmap 1229 to the flash storage 160b, without complementing the non-update portions between the areas updated by the host computer (FIG. 20). Since the update bitmap 1229 shows the update portions and the non-update portions corresponding to the new data 1310 before justification, the flash storage 160b can expand the packed data to the same data as the new data 1310 (on the cache memory 163) based on the update bitmap 1629 transferred from the storage controller 170. As for the non-updated portion generated after the expansion, it is possible to complement the same using the dummy data, or to complement the same by reading the old data from the flash memory 165. The flash storage 160b refers to the update bitmap 1629, and stores only the update portion out of the expanded data to the flash memory 165. Since the address after expansion can be recognized by referring to the update bitmap 1629, the packed data can be directly stored in the flash memory 165 by specifying the address using the update bitmap 1629, without first expanding the packed data. By transferring the packed data between the storage controller 170 and the flash storage 160b, it becomes possible to suppress the amount of data flow, and to efficiently utilize the path between the storage controller 170 and the flash storage 160b.

Further, it is possible to combine the method for transferring the packed data and the configuration for executing the parity computation by the flash storage 160b as described in Embodiment 2. When the method for transferring the packed data and the configuration for executing the parity computation by the flash storage 160b are combined, it is possible to transfer the data created by the first storage device having packed only the intermediate parity corresponding to the update portion (packed intermediate parity) and the updated bitmap to the storage controller, when the intermediate parity is read from the first flash storage 160b. In that case, the storage controller 170 transfers the packed intermediate parity and the update bitmap to the second storage device storing the old parity.

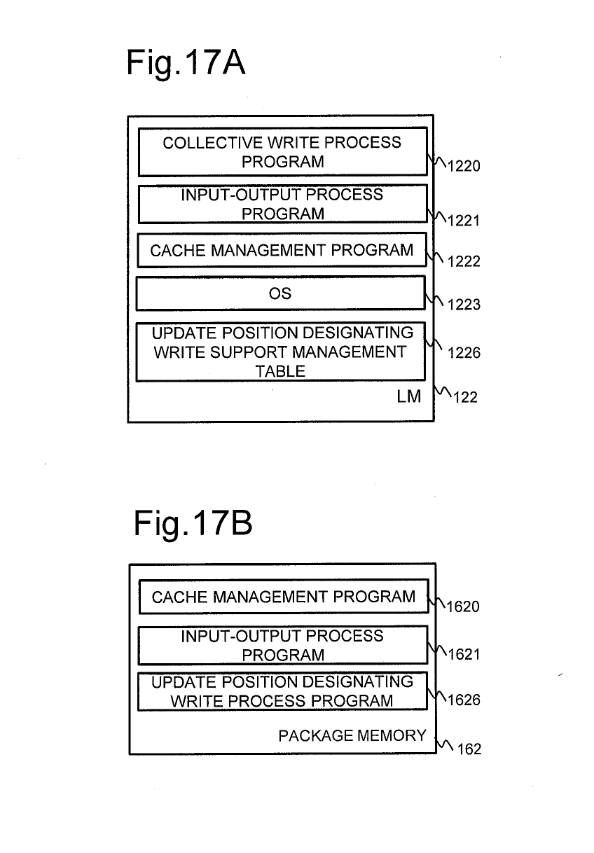

FIG. 17A illustrates an example of programs and control information stored in the LM 122 of the storage controller 170 according to Embodiment 4. The LM 122 stores a collective write process program 1220, an input-output process program 1221, a cache management program 1222, an OS 1223 and an update position designating write support management table 1226. The update position designating write support management table 1226 can be stored in the SM 132, the CM 131, the flash storage 160b, or in any area capable of being accessed by the storage controller 170. The details of the update position designating write support management table 1226 is a table similar to the compare write support management table 1224 (FIG. 4), which is used to manage whether the update position designating write is supported or not, instead of managing whether compare write is supported or not.

FIG. 17B illustrates an example of programs and control information stored in the package memory 162 within the flash storage 160b according to Embodiment 4. The package memory 162 stores a cache management program 1620, an input-output process program 1621, and an update position designating write process program 1626.

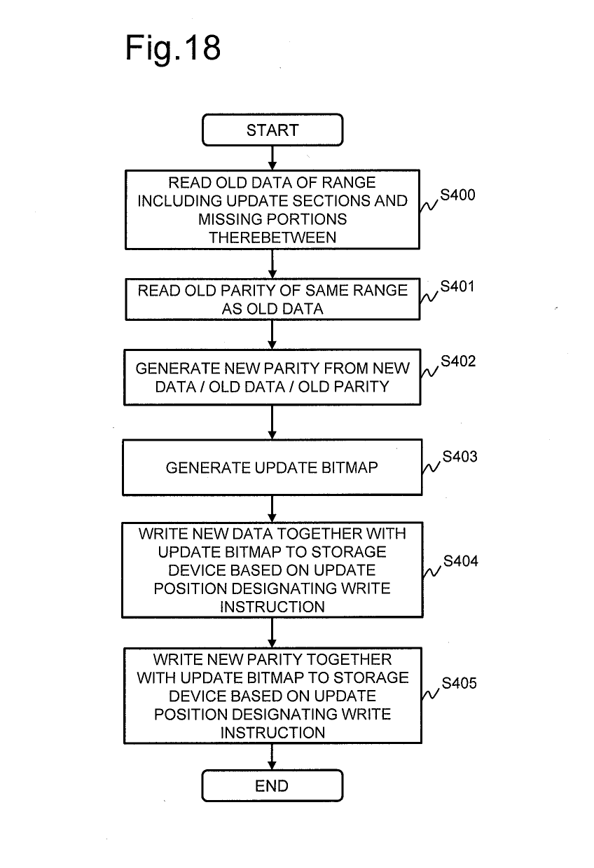

FIG. 18 is a flowchart illustrating the process performed by the collective write program 1220 of the storage controller 170. The collective write program 1220 operates to store the update portion within a fixed address range to the flash storage 160b at an appropriate timing. The processes of the respective steps described hereafter are performed by the processor 121 executing the collective write program 1220, unless stated otherwise.

At first, in step S400, the old data of the fixed address range including the updated section is read from the first flash storage 160b to the cache memory 131. Next, in step S401, the old parity corresponding to the data read in step S400 is read from the second flash storage 160b to create the redundant data (parity data). Normally, the first flash storage 160b accessed in step S400 and the second flash storage 160b accessed in step S401 differ.

Next, in step S402, the old data read in step S400, the old parity read in step S401 and the new data which is the update portion written from the host compute 30 are used to generate a new parity. The method for generating the new parity can utilize XOR operation, or any other operation method capable of ensuring redundancy.

Next, in step S403, an update bitmap 1229 is generated from the dirty bitmap. In order to generate the update bitmap 1229, it is necessary to convert the granularity of the dirty bitmap to the granularity of the update bitmap 1229 corresponding to the flash storage 160b. The granularity of the update bitmap 1229 corresponding to the flash storage 160b can be acquired from the flash storage 160b every time a write operation is performed, or can be determined in a fixed manner for each type of the flash storage 160b, or the granularity of the update bitmap 1229 can be notified to the flash storage 160b when the update position designating write request is output, as long as the granularity can be shared between the storage controller 170 and the flash storage 160b. Next, in step S404, based on the update position designating write instruction, the new data 1310 is written to the first flash storage 160b together with the update position designating bitmap 1229. Next, in step S405, the update bitmap 1229 and the new parity are stored in the second flash storage 160b, based on the update position designating write instruction.

The collective write process program 1220 of FIG. 18 can also be switched to normal write according to the number of updated sections within the write range or the load status of the storage controller 170, as in Embodiments 1 and 3. For example, when the load of the storage controller 170 is high, it is possible to execute a normal write process for cutting down the process generating the update bitmap 1229.

FIG. 18 has been described in consideration of RAID5, but other RAID types (such as RAID1 and RAID6) can also be adopted. For example, in the case of RAID1, steps S400, S401 and S405 which are processes for parity operation become unnecessary, but instead, new data should be written to multiple different flash storages 160b in step S404. In the case of RAID6, processes necessary for generating and updating the second parity are added to the process of FIG. 18.

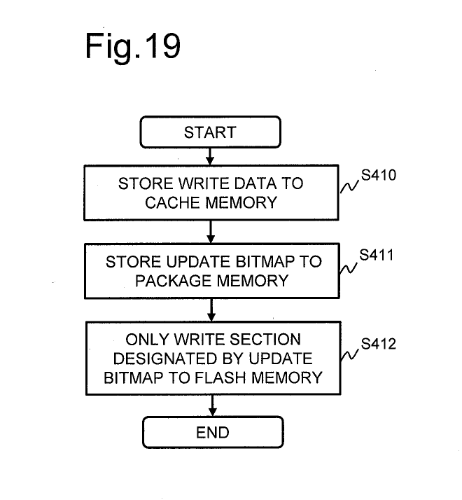

FIG. 19 is a flowchart illustrating the process executed by the update position designating write program 1626. The processes of the respective steps described below are performed by the package processor 161 of the flash storage 160b executing the update position designating write program 1626, unless stated otherwise. At first, in step S410, the data transferred from the storage controller 170 is stored in the cache memory 163. Next, in step S411, the update bitmap 1629 transferred from the storage controller 170 is stored in the package memory 162. Thereafter, in step S412, only the sections designated by the update bitmap 1629 are stored in the flash memory 165, and the process is ended.

According to another preferred embodiment, it is possible to switch between the update position designate write method and the normal write method according to the method requested by the storage controller, as in Embodiment 1.

Further, it is possible to combine Embodiment 4 and Embodiment 1 to have the flash storage 160b compare only the area designated by the storage controller 170 via the bitmap with the old data. By having the storage controller 170 designate the area to be compared, it becomes possible to cut down the amount of processing performed by the flash storage 160b when comparing the new data and the old data, and to cut down the amount of data written to the flash storage 160b when the host computer 30 has written the same data as the old data.

The above has described the storage subsystem 10 and the flash storage 160 according to the embodiment of the present invention. According to the storage subsystem of to the preferred embodiment of the present invention, the storage controller transmits a given range of data (such as the integral multiple of a stripe) in which write data having arrived from the host computer (new data) and other data (old data read from the storage device) exist in a mixture together with the compare write request to the storage device. The storage device reads the old data corresponding to the given range of data transmitted from the storage controller from the storage media, compares the same with the given range of data transmitted from the storage controller, and stores only the area changed from the old data out of the given range of data transmitted from the storage controller to the storage media, so that the number of rewrite of the storage media can be reduced.

Furthermore, multiple write data written based on multiple write requests having arrived from the host computer are included in the given range of data. According to the storage subsystem 10 of the present embodiment, the multiple write data can be written to the storage device via a single compare write request, so that both the reduction of process overhead when the storage controller issues commands to the storage device and the reduction of the number of times of rewrite of the storage media can be realized.

According further to the storage subsystem 10 of the present embodiment, whether to execute write to the storage device using the compare write request or to execute write to the storage device using a normal write request can be determined according for example to the storage status of write data in the cache memory or the status of load of the storage device, so that there is no need to perform an unnecessarily large amount of compare write processes in the storage device.

### REFERENCE SIGNS LIST

10: Storage system
20: Management computer
30: Host computer
40: Data network
170: Storage controller
100: FEPK
101: Interface
102: Transfer circuit
103: Buffer
120: MPPK
121: MP
122: LM
130: CMPK
131: CM
132: SM
140: BEPK
141: Interface
142: Transfer circuit
143: Buffer
144: FMPK
160a: Storage device
160b: Flash storage
161: Package processor
162: Package memory
163: Cache memory
164: Bus transfer device
165: Flash memory

1. A storage system comprising:
a controller having one or more processors and a cache memory, and one or more storage devices having a storage media; wherein
when the processor transmits a command including an instruction of a storage range of write data from a computer connected to the storage system and the write data to the storage device;
the storage device stores only a portion of the write data having a content that differs from a data before update of the write data stored in the storage device to the storage media.

2. The storage system according to claim 1, wherein
the processor transmits, as the command, a compare write request instructing that only a portion where the content differs from the data before update stored in the storage device is to be stored in the storage device to the storage device;
upon receiving the compare write request from the processor, the storage device compares the write data and a data before update of the write data stored in the storage range of the storage device; and
stores only a portion of the write data having a content that differs from the data before update to the storage media.

3. The storage system according to claim 2, wherein
the processor may transmit a write request instructing to store the write data to the storage device, instead of the compare write request; and
when the write request is received from the processor, the storage device stores all the received write data to the storage media.

4. The storage system according to claim 3, wherein
the processor is configured to store a write data received from the computer to the cache memory; and
if a portion not storing the write data received from the computer is included in the storage range, the processor transmits the compare write request together with the write data when storing the write data in the storage device.

5. The storage system according to claim 3, wherein
the processor monitors a load of the storage device; and
when storing the write data to the storage device, if a load of the storage device is lower than a given value, the processor transmits the compare write request.

6. The storage system according to claim 3, wherein
the storage media is a nonvolatile memory whose number of rewrites is limited; and
when storing the write data to the storage device, if the possible number of rewrites of the storage device is equal to or greater than a given value, the processor transmits the compare write request.

7. The storage system according to claim 6, wherein
the processor acquires information related to the possible number of rewrites of the storage device from the storage device, and based on the acquired information, transmits either the compare write request or the write request.

8. The storage system according to claim 1, wherein
the storage system has multiple storage devices, and constitutes a RAID group by (n+1) number of storage devices out of the multiple storage devices;
the RAID group is designed to store a parity computed from data stored in n number of storage devices out of the (n+1) number of storage devices to one of the storage devices not included in the n number of storage devices;
the processor transmits an intermediate parity write request together with an intermediate parity generated from the write data and a data before update of the write data to the storage device in which the parity is stored;
in response to the reception of the intermediate parity write request, the storage device storing the parity
generates a parity after update based on the parity and the intermediate parity stored in the storage device storing the parity; and
stores only a portion whose content differs from the parity of the parity after update to the storage media.

9. The storage system according to claim 8, wherein
the processor transmits a read request of an intermediate parity generated based on the write data and a data before update of the write data to a storage device storing the write data out of the n number of storage devices; and
the storage device having received a read request of the intermediate parity generates the intermediate parity by calculating an exclusive OR of a data before update of the write data and the write data stored in the storage device, and returns the generated intermediate parity to the processor.

10. The storage system according to claim 8, wherein
in response to receiving the intermediate parity write request, the storage device storing the parity
generates a parity after update by calculating an exclusive OR based on the parity and the intermediate parity stored in the storage device storing the parity; and
a range having a value of zero out of the generated parity after update will not store in the storage media.

11. The storage system according to claim 1, wherein
when the processor transmits a command including an instruction of information capable of specifying multiple areas within the storage range and the write data corresponding to the multiple areas within the storage range in addition to the storage range of the write data to the storage device;
the storage device compares only the data before update stored in the multiple areas within the storage range of the storage device with the write data, and stores only a portion where contents differ between the data before update and the write data having been compared in the storage media.

12. The storage system according to claim 11, wherein
the processor is designed to store a write data received from a host computer connected to the storage system to the cache memory; and
when the processor transmits a command including an instruction of information capable of specifying multiple areas within the storage range in addition to a storage range of the write data to the storage device, it generates a dummy data corresponding to a portion other than the multiple areas within the storage range, and transmits a data having merged the write data corresponding to the multiple areas and the dummy data as write data.

13. The storage system according to claim 11, wherein
when the processor transmits a command including an instruction of information capable of specifying multiple areas within the storage range in addition to a storage range of the write data to the storage device, it transmits only the write data corresponding to the multiple areas within the storage range as the write data.

14. A storage device comprising:
a package processor, a storage media, and a port for connecting to an external device, wherein
when the package processor receives a compare write request including an instruction of a storage range of write data and the write data from the external device;
it compares a data before update of the write data and the write data stored in the storage range of the storage device; and
stores only a portion having a different content as the data before update out of the write data to the storage media.

15. The storage device according to claim 14, wherein
when the package processor receives, in addition to the storage range of the write data, a command including an instruction of the information capable of specifying multiple areas within the storage range and the write data corresponding to the multiple areas within the storage range from the external device;
it compares only the data before update stored in the multiple areas within the storage range of the storage device with the write data, and stores only the portion where the content differs between the data before update and the write data being compared to the storage media.
